(19) United States
(12) Patent Application Publication
(10) Pub. No.: US 2005/0130524 A1
(43) Pub. Date: Jun. 16, 2005

(54) Dinner service pad

(76) Inventor: Leslie Nien, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/805,302

(22) Filed: Mar. 22, 2004

(30) Foreign Application Priority Data
Dec. 10, 2003 (TW) 092221712

(51) Int. Cl. B32B 3/00; B32B 5/02; B32B 27/04

(52) U.S. Cl. 442/59; 442/79; 442/80

(57) ABSTRACT

A dinner service pad includes a plurality of support sticks integrally woven with a woven fabric to provide a piece of decoration article wherein the support sticks are equidistantly wrapped in place by the woven fabric thereof, and an adhesive layer is coated at the upper and lower surfaces of the decoration article thereon respectively, securely binding together the woven fabric and the support sticks thereby to form a rigid and solid piece of the decoration article that is further cut into specific dinner pads via molds of different shapes. Thus, via the weaving texture of the woven fabric, the dinner pad thereof is equipped with artistic diagrams of rich colors and three-dimensional effect at the upper and lower surfaces thereon. And via the support sticks and the adhesive layers, the woven fabric is prevented from getting loose yarns in the cutting operation thereof. Besides, the adhesive layers thereof can also prevent food or gravy from getting inside to the support sticks and the woven fabric thereof, precisely protecting the upper and lower surfaces of the dinner pad thereof. And tissue is simply applied onto the adhesive layers to clean up the dinner pad in an easy and fast manner, facilitating the convenience of the dinner pad in practical use and cleaning up thereof.

### BACKGROUND OF THE INVENTION

The present invention is related to a dinner service pad, including a plurality of support sticks integrally woven with a woven fabric into a piece of decoration article wherein the support sticks are equidistantly wrapped in place by the woven fabric, and an adhesive layer is coated at the upper and lower surfaces of the decoration article thereon respectively, securely binding together the woven fabric and the support sticks thereby to form a rigid and solid piece of the decoration article that is further cut into specific dinner pads of various shapes with artistic diagrams of rich colors and three-dimensional effect disposed at the upper and lower surfaces thereon. Via the support sticks and the adhesive layers, the woven fabric is prevented from getting loose yarns in the cutting operation thereof. Besides, the adhesive layers thereof can also prevent food or gravy from getting inside to the support sticks and the woven fabric thereof, precisely protecting the upper and lower surfaces of the dinner pad thereof. And tissue is simply applied onto the adhesive layers to clean up the dinner pad in an easy and fast manner.

Please refer to FIG. 1. A conventional dinner service pad is made up of a plurality of hollow beads 11 strung and woven with weaving yarns 12 into a dinner pad 10 with three-dimensional effect as shown in FIG. 1.

There are some drawbacks to such conventional dinner service pad. First, a number of hollow beads 11 are required to be woven with the weaving yarns 12 to provide a dinner pad 10 wherein the hollow beads 11 must be processed in advance before woven with the weaving yarns 12 thereof. The processing and weaving operations thereof are both complicated and time-consuming, which can uneconomically boost the cost of production and make the dinner pad 10 uncompetitive in the market. Second, the bead 11 are directly contacted with dinnerware in practical use, which not only easily damage the surface of the beads 11 due to the friction thereof, but also can easily tarnish the beads 11 in case food or gravy spilt onto the beads 11 or into hollow spots 101 of the dinner pad 10 thereof and result in the inconvenience of cleaning up thereof in practical use. Third, the beads 11 of the dinner pad 10 are made of plastics, which can increase the burden of the environment in recycle. When burned off in disposal, the beads 11 thereof can also cause air pollution and harm the environment.

### SUMMARY OF THE PRESENT INVENTION

It is, therefore, the primary purpose of the present invention to provide a dinner service pad, including a plurality of support sticks integrally woven with a woven fabric into a piece of decoration article wherein an adhesive layer is coated at the upper and lower surfaces of the decoration article thereon respectively, securely binding the woven fabric and the support sticks thereby to form a hard and solid piece of the decoration article which is further cut into specific dinner pads via molds of different shapes, facilitating a fast and easy processing thereof so as to reduce the cost of production and achieve economical efficiency thereof.

It is, therefore, the second purpose of the present invention to provide a dinner service pad wherein, via the weaving texture of the woven fabric, the dinner pad thereof is equipped with artistic diagrams of rich colors and three-dimensional effect at the upper and lower surfaces thereon; via the support sticks and the adhesive layers, the woven fabric is prevented from getting loose yarns in the cutting operation thereof; besides, the adhesive layers thereof can also refrain the support sticks and the woven fabric from directly contacting with the dinnerware so as to avoid the damage of frication in use, precisely protecting the upper and lower surfaces of the dinner pad thereof to prolong the lifespan of the dinner pad thereof.

It is, therefore, the third purpose of the present invention to provide a dinner service pad wherein, via the support sticks made of bamboo materials, the woven fabric, and the adhesive layer of food-used fastening agent, the dinner pad thereof is easily disposed in recycle or burning off without causing any burden or air pollution to the environment to provide an eco-friendly dinner pad thereof.

It is, therefore, the fourth purpose of the present invention to provide a dinner service pad wherein both the upper and lower surfaces of the dinner pad are securely protected by the adhesive layers so that, in case food or gravy spills over onto the dinner pad thereof, the adhesive layers thereof can prevent food or gravy from getting inside to the support sticks and the woven fabric thereof, and tissue is simply applied onto the adhesive layers to clean up the dinner pad in an easy and fast manner.

### BRIEF DESCRIPTION OF THE DRAWINGS

FIG. 1 is a perspective view of a conventional dinner service pad.

FIG. 2 is a perspective exploded view of the present invention.

FIG. 3 is a cross sectional view of the present invention.

FIG. 4 is a diagram showing a finished dinner pad of the present invention.

FIG. 5 is a diagram showing another finished dinner pad of the present invention.

FIG. 6 is a perspective exploded view of another embodiment of the present invention.

FIG. 7 is a cross sectional view of another embodiment of the present invention.

FIG. 8 is a perspective view of a third embodiment of the present invention.

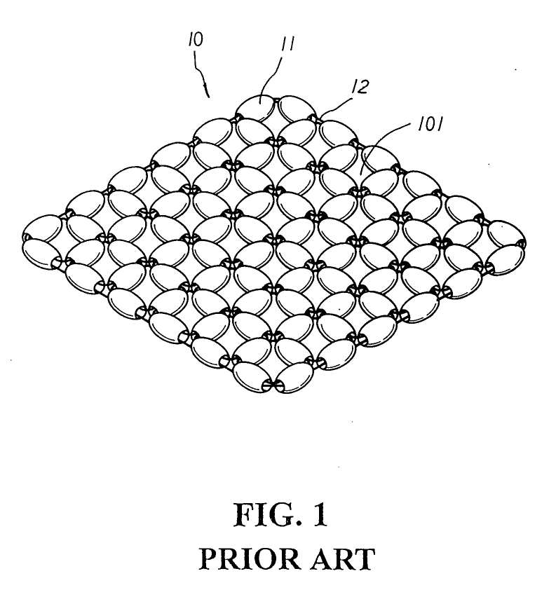

### DETAILED DESCRIPTION OF THE PREFERRED EMBODIMENTS

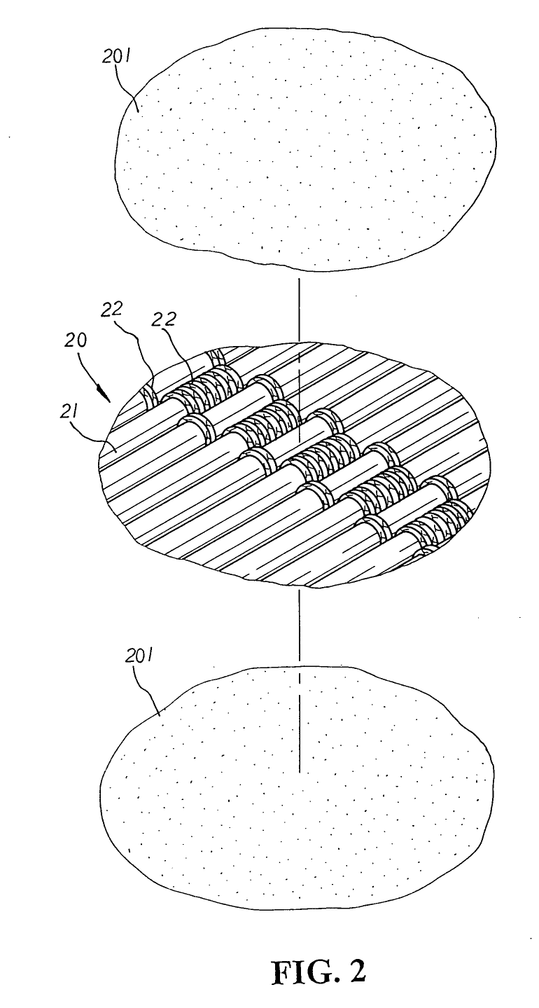

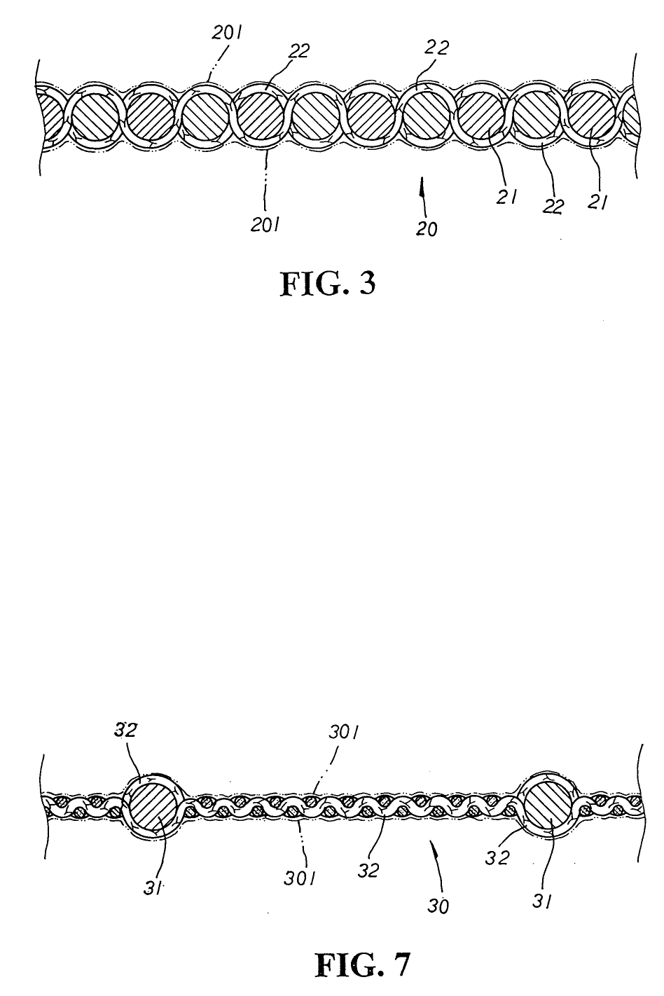

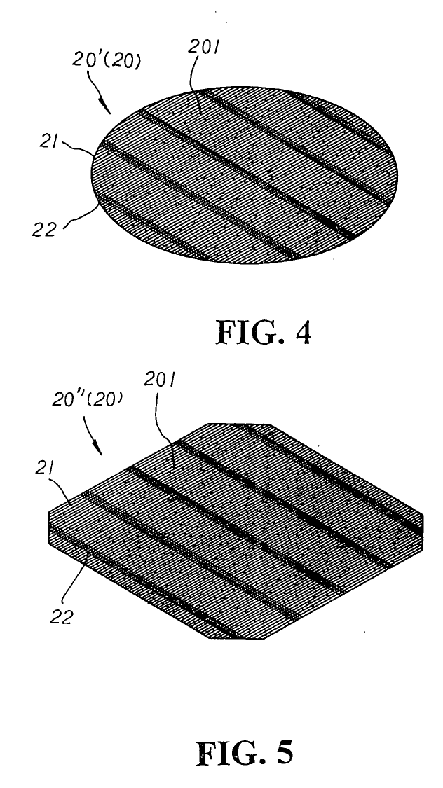

Please refer to FIGS. 2 to 5 inclusive. The present invention is related to a dinner service pad, including a plurality of mutually juxtaposed support sticks 21 of bamboo materials, and a woven fabric 22 integrally woven with the support sticks 21 in equal space to provide a piece of decoration article 20. The support sticks 21 are equidistantly wrapped in place by the woven fabric 22. An adhesive layer 201 of food-used and transparent fastening agent is coated at the upper and lower surfaces of the decoration article 20 thereon respectively to securely bind together the weaving spots of the woven fabric 20 and each support stick 21 thereof to form a rigid and solid piece of the decoration article 20 thereof. Diagrams of various designs and colors can be integrally woven at the surfaces of the decoration articles 20 before the decoration article 20 thereof is dissevered via molds of different shaped into specific dinner pads such as a round dinner pad 20′ or a polygonal dinner pad 20″ as shown in FIGS. 4, 5. Via the weaving texture of the woven fabric 22, the dinner pad 20′, or 20″ is equipped with artistic diagrams of rich colors and three-dimensional effect at the upper and lower surfaces thereon. And securely hold by the support sticks 21 and coated with the adhesive layers 201, the woven fabric 22 is prevented from getting loose yarns in the cutting operation thereof. Besides, the adhesive layers 201 thereof can precisely refrain the support sticks 21 and the woven fabric 22 of the dinner pad 20′ from directly contacting with the dinnerware so as to avoid the damage of frication in use and prolong the lifespan of the dinner pad 20′ thereof. Thus, both the upper and lower surfaces of the dinner pad 20′, 20″ are securely protected by the adhesive layers 201. In case food or gravy spills over onto the dinner pad 20′ 20″, the adhesive layers 201 can precisely prevent food or gravy from getting inside to the support sticks 21 and the woven fabric 22 thereof. And tissue is simply applied onto the adhesive layers 201 to clean up the dinner pad 20′, 20″ in an easy and fast manner, facilitating the convenience of the dinner pad 20′, 20″ thereof in practical use and cleaning up thereof.

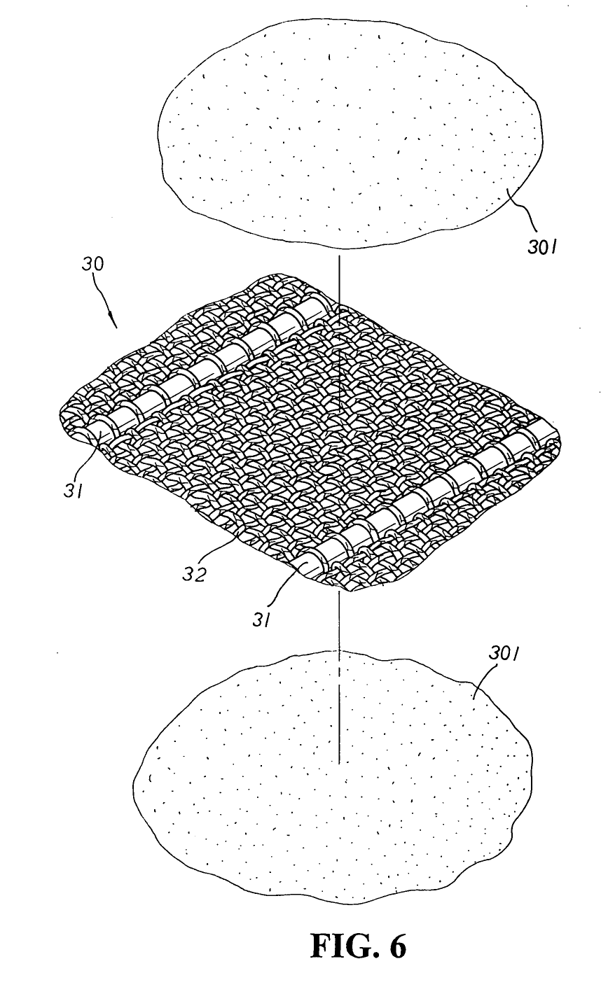

Please refer to FIGS. 6 to 7 inclusive. The present invention can also be equipped with a plurality of support sticks 31 each individually arranged in equal space from the others, and a woven fabric 32 integrally woven with the support sticks 31 to provide a piece of decoration article 30. The support sticks 31 are equidistantly wrapped in place by the woven fabric 32 thereof. An adhesive layer 301 is coated at the upper and lower surfaces of the decoration article 30 thereon respectively, securely binding together the weaving spots of the woven fabric 32 and each support stick 31 thereof to form a rigid and solid piece of the decoration article 30 thereof that is further cut into specific dinner pads of different shapes via molds.

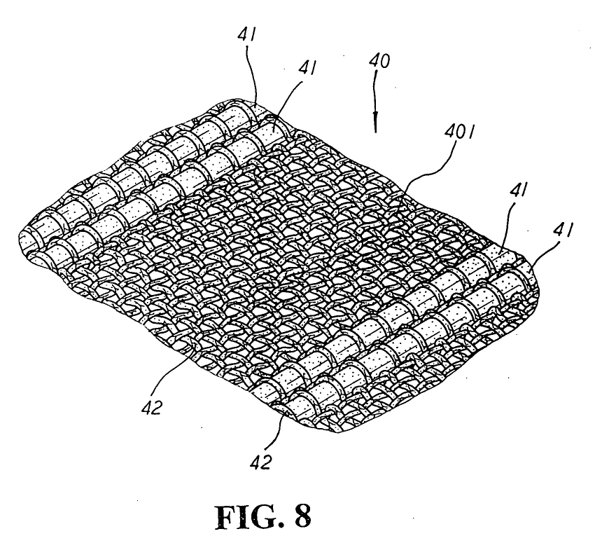

Please refer to FIG. 8. The present invention can also have a plurality of support sticks 41 equidistantly arranged in pairs, and a woven fabric 42 integrally woven with the paired-up support sticks 41 into a piece of decoration article 40. The support sticks 41 are wrapped in place by the woven fabric 42 in equal space. An adhesive layer 401 is coated at the upper and lower surfaces of the decoration article 40 thereon respectively, securely binding together the weaving spots of the woven fabric 32 and each support stick 31 thereof to form a rigid and solid piece of the decoration article 40 thereof that is further cut into specific dinner pads of various shapes via molds.

1. A dinner service pad, including a plurality of support sticks integrally woven with a woven fabric to provide a piece of decoration article wherein the support sticks are equidistantly wrapped in place by the woven fabric thereof, and an adhesive layer is coated at the upper and lower surfaces of the decoration article thereon respectively, securely binding together the weaving spots of the woven fabric and each support stick thereof to form a rigid and solid piece of the decoration article that is further cut into specific dinner pads via molds of different shapes; thus, via the weaving texture of the woven fabric, the dinner pad thereof is equipped with artistic diagrams of rich colors and three-dimensional effect at the upper and lower surfaces thereon, and via the support sticks and the adhesive layers, the woven fabric is prevented from getting loose yarns in the cutting operation thereof; besides, the adhesive layers thereof can also refrain the support sticks and the woven fabric of the dinner pad from directly contacting with the dinnerware so as to avoid the damage of frication in use; in case food or gravy spills over onto the dinner pad thereof, the adhesive layers thereof can prevent food or gravy from getting inside to the support sticks and the woven fabric thereof, precisely protecting the upper and lower surfaces of the dinner pad thereof, and tissue is simply applied onto the adhesive layers to clean up the dinner pad in an easy and fast manner, facilitating the convenience of the dinner pad in practical use and cleaning up thereof.

2. The dinner service pad as claimed in claim 1 wherein the support sticks thereof can be made of bamboo materials.

3. The dinner service pad as claimed in claim 1 wherein the adhesive layer thereof can be made of food-used and transparent fastening agent.

4. The dinner service pad as claimed in claim 1 wherein the support sticks thereof can be mutually juxtaposed and equidistantly woven with the woven fabric to provide an integral piece of the decoration article thereof.

5. The dinner service pad as claimed in claim 1 wherein each support stick can also be individually arranged in equal space from the others and integrally woven with the woven fabric to form the decoration article thereof.

6. The dinner service pad as claimed in claim 1 wherein the support sticks thereof can also be equidistantly arranged in pairs and integrally woven with the woven fabric to form the decoration article thereof.
